(19) United States
(12) Patent Application Publication
(10) Pub. No.: US 2009/0064897 A1
(43) Pub. Date: Mar. 12, 2009

(54) UNIVERSAL TINT BASES AND COATING SYSTEMS EMPLOYING SUCH TINT BASES

(75) Inventors: Sean Philippe GUERTIN, East St. Paul (CA); Charles Guertin, Winnipeg (CA); Ron Chemerika, Winnipeg (CA); Thi Nguyen, Winnipeg (CA)

Correspondence Address: OBLON, SPIVAK, MCCLELLAND MAIER & NEUSTADT, P.C., 1940 DUKE STREET, ALEXANDRIA, VA, 22314, US

(73) Assignee: Guertin, Coatings, Sealants and Polymers, Ltd., Winnipeg (CA)

(21) Appl. No.: 11/854,108

(22) Filed: Sep. 12, 2007

(51) Int. Cl. C08L 1/00

(52) U.S. Cl. 106/200.1; 106/218; 106/287.24; 106/287.25; 106/400; 427/2.31

(57) ABSTRACT

Tint bases include dual functional polymers and pigments. Methods of preparing tint bases include obtaining a dual functional polymer, obtaining a pigment, and combining the dual functional polymer and the pigment. Coating compositions, kits, and methods of coating employing the tint bases are also provided.

### BACKGROUND

The present invention relates to tint bases including dual functional polymers and pigments. The present invention further relates to methods of preparing such tint bases, coating compositions and kits including such tint bases, and methods of coating employing such tint bases.

Tint systems began as sets of tints suitable for use with either non-functional physically drying systems or air oxidized systems. Some tint systems were formulated to allow for use in single component coating systems employing either physically drying or curing through air oxidation. Other tint systems, when combined with an appropriate clear binder, were formulated for use in two component coating systems employing isocyanate crosslinking to form polyurethanes.

Today's tint systems include sets of tints based on non-functional polymers, tints based on polymers with only one type of functionality, or so-called ‘resin-free’ tint systems. These colored tints are mixed with one or more clear binders having a single type of reactive functionality, optionally along with solvents and additives, to produce the first component of two component systems. These first components are combined with second components at the point of use. The second components include a suitable co-reactant for the reactive functional group found in the first component, optionally along with solvents and additives.

Current commercial systems usually contain isocyanate functional co-reactants in the second component. Some alternative systems use a single alternate cure mechanism and are touted as “NISO” (non-isocyanate) or “Isocyanate-Free” systems. These systems using alternative non-isocyanate curing mechanisms are designed for applications where worker health and safety concerns require the removal of isocyanate containing materials in coating applications.

Both isocyanate and non-isocyanate systems suffer from the fact that a completely different tint system is required for each. Should a coatings supplier want to satisfy customers by supplying both types of systems, two completely different tint systems would be required. This requirement necessitates carrying twice the inventory of tint systems and creates the potential for error in selecting the correct tint system for a selected coating system.

Tint systems based on non-functional polymers, or ‘resin-free’ systems may, depending upon the compatibility of the constituent tints, be used with both isocyanate crosslinked systems and non-isocyanate systems. However, such systems suffer from the fact that a significant amount of tint binder remains unreacted with the final coating film. The presence of unreacted tint binder results in degraded performance.

U.S. Pat. No. 6,413,306 to Kraiter describes a wetting agent that may include a variety of functional groups, that may be crosslinked in a variety of different ways. However, a tint system employing such a wetting agent must be formulated to include a further binder to provide acceptable volume, viscosity and reactivity. As the additional binders do not have more than one functional group type, a different tint system remains necessary for each different coating type.

### SUMMARY

In view of the above described shortcomings of known tint systems, the present inventors developed a single base for tints that can be used in a variety of coatings systems. Such tint bases eliminate the need for increased inventory and the potential for error in choosing the correct version of a particular tint associated with supplying multiple coating systems that require separate tint bases. The tint bases according to the present invention make it possible to maintain all of the desirable properties of known coating systems that employ separate tint bases while eliminating the need for such separate tint bases.

In various exemplary embodiments, the present invention is directed to a tint base including a dual functional polymer and a pigment.

In various exemplary embodiments, the present invention is directed to a coating composition including a tint base as described herein and a coating base.

In various exemplary embodiments, the present invention is directed to a method of coating including applying a coating composition as described herein to a substrate, and curing the coating composition.

In various exemplary embodiments, the present invention is directed to a kit including a first container including a first coating composition and a second container including a second coating composition. The first coating composition includes a coating composition as described herein and the second coating composition includes a reactive component.

In various exemplary embodiments, the present invention is directed to a method of coating including obtaining a kit as described herein, mixing a first coating composition of the kit and a second coating composition of the kit to obtain a combined coating composition, applying the combined coating composition to a substrate, and curing the combined coating composition.

In various exemplary embodiments, the present invention is directed to a method of preparing a tint base including obtaining a dual functional polymer, obtaining a pigment, and combining the dual functional polymer and the pigment.

The above objects highlight certain aspects of the invention. Additional objects, aspects and embodiments of the invention are found in the following detailed description of the invention.

### DETAILED DESCRIPTION OF EXEMPLARY EMBODIMENTS

Unless specifically defined, all technical and scientific terms used herein have the same meaning as commonly understood by a skilled artisan in coatings science and/or chemical engineering.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

Exemplary tint bases according to the present invention include dual functional polymers and pigments. Dual functional polymers can include any polymers suitable for use in a tint base that include at least two different types of functional groups. The functional groups are selected so that tint bases including such dual functional polymers can be used in at least two different types of coating systems having at least two different curing mechanisms. That is, a single tint base according to the present invention will be usable in at least two coating systems employing different cure mechanisms, while known tint bases must be keyed to the particular coating systems and particular cure mechanisms with which they are to be employed.

As indicated above, the dual functional polymer may be any polymer suitable for use in a tint base. In embodiments, the dual functional polymer is a condensation polymer. Suitable polymers may include polyesters and poly(meth)acrylates that can be synthesized with two different types of functionality (e.g., both hydroxyl functionality and acetoacetyl functionality). In embodiments, dual functional polymers according to the present invention have a number average molecular weight of from 1,000 to 10,000. In still further embodiments, dual functional polymers according to the present invention have a number average molecular weight of from 1,000 to 6,000.

Dual functional polymers according to the present invention may include a plurality of hydroxyl functional groups and a plurality of acetoacetyl functional groups. The hydroxyl and acetoacetyl functional groups of the dual functional polymer desirably have sufficient reactivity to readily react with isocyanate and melamine crosslinkers. In embodiments, the dual functional polymers of the present invention include sufficient hydroxyl and acetoacetyl functional groups to form a crosslinked film when combined with suitable acrylates in the manner described in U.S. Pat. No. 5,017,649 to Clemens, the disclosure of which is incorporated herein by reference in its entirety. In embodiments, the dual functional polymers of the present invention include sufficient hydroxyl and acetoacetyl functional groups to form enamine crosslinked films when combined with polyamines. In embodiments, the dual functional polymers of the present invention include sufficient hydroxyl and acetoacetyl functional groups to form films through oxidative cure mechanisms. Further, the dual functional polymers of the present invention desirably include sufficient hydroxyl groups to ensure acceptable pigment and substrate wetting. In embodiments, the dual functional polymer of the present invention includes from 5 to 80% hydroxyl functional groups and from 20 to 95% acetoacetyl functional groups relative to a total number of hydroxyl functional groups and acetoacetyl functional groups. In further embodiments, the dual functional polymer of the present invention includes from 10 to 80% hydroxyl functional groups and from 20 to 90% acetoacetyl functional groups relative to a total number of hydroxyl functional groups and acetoacetyl functional groups. In still further embodiments, the dual functional polymer of the present invention includes from 20 to 60% hydroxyl functional groups and from 40 to 80% acetoacetyl functional groups relative to a total number of hydroxyl functional groups and acetoacetyl functional groups.

As indicated above, tint bases according to the present invention include dual functional polymers and pigments. In embodiments, the pigments may be selected from one or more organic and inorganic pigments. Exemplary pigments may include one or more pigments selected from C.I. Black #7, C.I. Violet #23, C.I. Blue #60, C.I. Blue #15:2, C.I. Blue #15:4, C.I. Green #7, C.I. Yellow #184, C.I. Yellow #110, C.I. Orange #36, C.I. Red #42, C.I. Red #254, C.I. Violet #19, C.I. Violet #19, C.I. Red #179, C.I. Yellow #42, C.I. Red #101, C.I. Metal #1, and C.I. White #6. In embodiments, pigments may include effect pigments, such as aluminum flakes. Pigments may further include a dispersing agent.

In addition to the dual functional polymers and pigments described above, the tint bases of the present invention may further include wetting agents.

The present invention is further directed to coating compositions including a tint base as described above and a coating base. In embodiments, the coating base is a clear binder. The clear binders employed in the coating compositions of the present invention are selected based on the curing technique that will be applied to that coating composition. For example, if the coating composition is to form the first component of a two component system, the clear binder may include a urethane binder or a Michael addition binder. If the coating composition is to be a single component system, the clear binder may include a melamine binder, an epoxy binder, a binder curable by an oxidative crosslinking reaction, or a non-reactive lacquer. The amounts of tint base and coating base in coating compositions according to the present invention are not particularly limited. For example, an exemplary coating composition may include tint base and coating base in a weight ratio of from about 1:1 to about 1:9, or in any other suitable weight ratio.

The coating compositions according to the present invention may further include one or more modifiers, such as flow additives, ultraviolet absorbers and reaction catalysts. The present invention is further directed to methods of coating employing the coating compositions described above. Exemplary methods of coating include applying a coating composition as described above to a substrate, and curing the coating composition. Methods of curing are not particularly limited, and may be specific to the particular coating base that is employed. Curing the composition may involve the application of chemical or physical means. In embodiments, curing may simply involve allowing a coating composition to dry under ambient conditions.

The present invention is directed to kits including a first container including a first coating composition, and optionally a second container including a second coating composition. Exemplary kits may further include instructions for preparing and applying a coating, e.g., printed instructions provided on or with containers holding the first and/or second coating compositions of the kit. In embodiments, the first coating composition includes a coating composition as described above. In embodiments in which a second coating composition is required (two-component systems), the second coating composition includes a reactive component. Exemplary reactive components include polyisocyanates, Michael addition base catalysts, and epoxy curing agents. The amount of reactive component in the second coating composition is not particularly limited, so long as the second coating composition includes sufficient reactivity to complement the reactivity of the first coating composition. In embodiments, the first coating composition and the second coating composition may be present in a kit in a volume ratio of about 3:1, or in any other suitable volume ratio. In embodiments, the first coating composition includes a coating base including acetoacetyl functional polymers and acrylate functional urethane crosslinkers, and the second coating composition comprises a strong base catalyst.

In an exemplary two component kit according to the present invention, a first coating composition includes a tint base as described above and a hydroxylated polyol clear base, and a second coating composition includes one or more of biurets of hexamethylene diisocyanate, isocyanurate trimers of hexamethylene diisocyanate, isocyanurate trimers of isophorone diisocyanate, one or more moisture scavengers, and one or more compatible solvents. In a further exemplary two component kit according to the present invention, a first coating composition includes a tint base as described above and an acetoacetylated polymer clear base, and a second coating composition includes one or more of cycloaliphatic amines, amine functional polyethers, and amine functional acrylic polymers. In a still further exemplary two component kit according to the present invention, a first coating composition includes a tint base as described above and an epoxy clear base, and a second coating composition includes one or more of amine functional polyamides, amine functional ‘amidoamines,’ aliphatic amines, cycloaliphatic amines, amine functional polyethers, amine functional acrylic polymers, accelerators/catalysts, and one or more compatible solvents.

In an exemplary one component kit according to the present invention, the coating composition includes a tint base as described above, a melamine clear binder and one or more of hydroxylated polymers/oligomers, acetoacetyl functional polymers/oligomers, glycidyl functional polymers/oligomers, dual-/poly-functional polymers/oligomers, melamine crosslinkers, one or more flow, sag resistance, or weathering modifiers, and one or more compatible solvents. In a further exemplary one component kit according to the present invention, the coating composition includes a tint base as described above and one or more of unsaturated fatty acid or oil modified polyester polymers, unsaturated fatty acid or oil modified acrylic polymers, unsaturated fatty acid or oil modified reactive diluents, one or more acetoacetyl, (meth)acrylate or diene functional reactive diluents, catalysts for promoting oxidative crosslinking, one or more flow, sag resistance, or weathering modifiers, and one or more compatible solvents. In a still further exemplary one component kit according to the present invention, the coating composition includes a tint base as described above, and one or more of nitrocellulose resins, thermoplastic acrylic resins, thermoplastic polyurethane resins, saturated fatty acid or oil based alkyd resins, one or more flow, sag resistance, or weathering modifiers, and one or more compatible solvents.

The kits described above may be employed to perform coating. In embodiments, methods of coating according to the present invention include obtaining a kit as described above, mixing the first coating composition and the second coating composition of the kit to obtain a combined coating composition, applying the combined coating composition to a substrate, and curing the combined coating composition. The particulars of mixing the first coating composition and the second coating composition are not particularly limited, and selecting particulars, such as mixing equipment and mixing time, is within the ability of one of ordinary skill in the art.

The mechanics of applying coating compositions obtained using kits according to the present invention as described above are not particularly limited, and determining specific modes for practicing the methods described herein is generally within the ability of one of ordinary skill in the art. In practicing exemplary methods according to the present invention, coating compositions may be applied to any suitable substrates including, but not limited to, substrates such as metals, plastics, woods, and paper. Coating compositions according to the present invention may applied to such substrates by any suitable techniques including, but not limited to, spray methods, knife coating, reverse roll coating, application by brush, and application by roller. Coating compositions according to the present invention may be applied to any suitable thickness. In embodiments, coating compositions are applied to a thickness of from about 20 to about 150 microns.

Application of coating compositions may be conducted under any suitable atmospheric conditions including, but not limited to ambient temperature and relative humidity. In embodiments, application of coating compositions may be conducted at temperature of from about 15 to about 45° C. and a relative humidity for from about 0 to about 90%.

Curing of applied coating compositions according to the present invention can be carried out by any suitable means under any suitable conditions. Selecting appropriate curing means and conditions is within the ability of one of ordinary skill in the art. In embodiments, curing will take place under ambient conditions. Alternatively, curing can take place in an oven. In embodiments, curing is carried out at a temperature of about 130° C. or less for a period of time of 20 minutes or less.

The thickness of films obtained by applying and curing coating compositions according to the present invention will vary depending on numerous factors including, but not limited to, the thickness at which the coating composition is applied, the substrate to which the coating composition is applied, the mechanism by which the coating is applied, the atmospheric conditions under which application and curing are carried out, the mechanism by which curing is carried out, etc. In embodiments, films obtained by applying and curing coating compositions according to the present invention will have a thickness from about 20 to about 150 microns.

The present invention is further directed to methods of preparing tint bases, such as described above. In embodiments, methods of preparing a tint base include obtaining a dual functional polymer, obtaining a pigment, and combining the dual functional polymer and the pigment. In embodiments, obtaining a dual functional polymer includes preparing a dual functional polymer. In embodiments, preparing a dual functional polymer includes preparing a polyester having hydroxyl functional groups by esterification, and acetoacetylating a plurality of the hydroxyl functional groups by transesterification so that the dual functional polymer includes both hydroxyl functional groups and acetoacetyl functional groups. In further embodiments, preparing a dual functional polymer comprises preparing a dual functional poly(meth)acrylate by free radical polymerization of hydroxyl functional (meth)acrylate and acetoacetyl functional (meth)acrylate.

In embodiments, obtaining the pigment includes obtaining a pigment selected from the group consisting of organic and inorganic pigments. Obtaining the pigment may further include preparing a dispersion of the pigment in a dispersing agent. In embodiments, combining the dual functional polymer and the pigment comprises dispersing the pigment in the dual functional polymer. Dispersing the pigment in the dual functional polymer comprises dispersing with an apparatus selected from the group consisting of a bead mill, a ball mill, a two roll mill and a three roll mill.

The above written description of the invention provides a manner and process of making and using it such that any person skilled in this art is enabled to make and use the same, this enablement being provided in particular for the subject matter of the appended claims, which make up a part of the original description.

As used above, the phrases “selected from the group consisting of,” “chosen from,” and the like include mixtures of the specified materials.

Where a numerical limit or range is stated herein, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### EXAMPLES

Examples are prepared in accordance with embodiments of the present invention, as described below. In the course of the Examples, various parameters are measured. The parameters are measured by the following procedures:

Viscosity—Measured according to ASTM D-1545;

Dry Time—Measured using a Circular Dry Time Recorder according to the procedure set forth in ASTM MNL 17;

Gloss—Measured at 60° and 20° angles of incidence according to ASTM D-523;

Pencil Hardness—Measured according to ASTM D-3363 using a Wolff-Wilborn pencil holding cart;

Mandrel Bend—Measured according to ASTM D-522;

Direct and Reverse Impact Resistance—Measured according to ASTM D-2794;

Solvent Rub Resistance—Measured using methylethyl ketone according to ASTM D-5402.

### Preparation of a Caprolactone Polyol Intermediate

Trimethylol propane and an amount of ε-caprolactone monomer sufficient to produce a 100 equivalent weight triol are reacted in the presence of catalyst to completion. The resulting material is a clear liquid having a viscosity of 15±2 poises.

### Polymer Example 1

A sufficient amount of tertiary butyl acetoacetate is added to the hydroxylated caprolactone triol obtained above to acetoacetylate 85% of theoretically available hydroxyls. Reflux solvent is added, the product is brought up to reflux temperature, and the transesterification reaction is allowed to proceed until the theoretical amount of tertiary butyl alcohol and reflux solvent is collected. The 85% acetoacetyl/15% hydroxyl dual functional polymer is cooled and decanted. The theoretical hydroxyl equivalent weight of this polymer was calculated to be 1150±10 and the acetoacetyl equivalent weight is calculated to be 202±2. The viscosity is determined to be 2.5±0.2 poise.

### Comparative Polymer Example 1A

A sufficient amount of tertiary butyl acetoacetate is added to the hydroxylated caprolactone triol obtained above to acetoacetylate 95% of the theoretically available hydroxyls. Reflux solvent is added, the product is brought up to reflux temperature, and the transesterification reaction is allowed to proceed until the theoretical amount of tertiary butyl alcohol and reflux solvent is collected. The 95% acetoacetyl/5% hydroxyl dual functional polymer is cooled and decanted. The theoretical hydroxyl equivalent weight of this polymer was calculated to be 3580±10 and the acetoacetyl equivalent weight is calculated to be 190±2. The viscosity is determined to be 1.5±0.2 poise.

### Non-Isocyanate Coatings

White non-isocyanate coatings curable through Michael Addition reaction, as described for example in U.S. Pat. No. 5,132,367 to Chan, the disclosure of which is incorporated herein by reference in its entirety, are formulated using Polymer Example 1 and Comparative Polymer Example 1A. The same pigment, acetoacetylated polyester binder, polyacrylate blend, solvents and additives are used in both instances and both coatings are catalyzed with the same base solution. The coating obtained using Polymer Example 1 cures to a smooth high gloss defect free film. The coating using the Comparative Polymer Example 1A cures to a film of moderate gloss having many craters and other film defects indicating poor wetting and compatibility.

### Preparation of a Hydroxyl Functional Polyester Polyol Intermediate

A blend of phthalic anhydride, isophthalic acid, and various glycols such that there is a molar excess of hydroxyl groups, is melted and condensed under reflux conditions using xylene as the reflux solvent. The reaction is continued until an acid value of less than one is reached. An acid scavenger is added to further reduce the residual acid. In the final hours of the reaction the reflux solvent is distilled off. The completed intermediate has a theoretical hydroxyl equivalent weight of 470±5.

### Example 2

A sufficient amount of tertiary butyl acetoacetate is added to the hydroxylated polyester prepolymer obtained above to acetoacetylate 80% of the theoretically available hydroxyls. Reflux solvent is added, the product is brought up to reflux temperature, and the transesterification reaction is allowed to proceed until the theoretical amount of tertiary butyl alcohol and reflux solvent is collected. The 80% acetoacetyl/20% hydroxyl dual functional polymer is diluted to 80% by weight solids, cooled and decanted. The theoretical hydroxyl equivalent weight of this polymer is calculated to 2600±5 and the acetoacetyl equivalent weight is calculated to be 675±5.

### Example 3

A sufficient amount tertiary butyl acetoacetate is added to the hydroxylated polyester prepolymer obtained above to acetoacetylate 20% of the theoretically available hydroxyls. Reflux solvent is added, the product is brought up to reflux temperature, and the transesterification reaction is allowed to proceed until the theoretical amount of tertiary butyl alcohol and reflux solvent is collected. The 20% acetoacetyl/80% hydroxyl dual functional polymer is diluted to 80% by weight solids, cooled and decanted. The theoretical hydroxyl equivalent weight of this polymer is calculated to be 610±5 and the acetoacetyl equivalent weight is calculated to be 2450±5.

### Example 4

A sufficient amount of tertiary butyl acetoacetate is added to the hydroxylated polyester prepolymer obtained above to acetoacetylate 60% of the theoretically available hydroxyls. Reflux solvent is added, the product is brought up to reflux temperature, and the transesterification reaction is allowed to proceed until the theoretical amount of tertiary butyl alcohol and reflux solvent is collected. The 60% acetoacetyl/40% hydroxyl dual functional polymer is diluted to 80% by weight solids, cooled and decanted. The theoretical hydroxyl equivalent weight of this polymer is calculated to be 1285±5 and the acetoacetyl equivalent weight is calculated to be 875±5.

### Preparation of Tint Bases

### Examples 4a-4r

Tint bases are prepared from the binder of Example 4, various commercially available wetting agents, solvents, additives to reduce air entrainment and improve flow, and the pigments listed in Table 1 below. In each case a stable, high tint strength, non-flocculating dispersion is obtained, once an appropriate wetting agent is found.

TABLE 1

| Example | Color | C.I. Name |
|---|---|---|
| 4a | Black | Pigment Black #7 |
| 4b | Blue Violet | Pigment Violet #23 |
| 4c | Blue | Pigment Blue #60 |
| 4d | Reddish Blue | Pigment Blue #15:2 |
| 4e | Greenish Blue | Pigment Blue #15:4 |
| 4f | Bluish Green | Pigment Green #7 |
| 4g | Greenish Yellow | Pigment Yellow #184 |
| 4h | Reddish Yellow | Pigment Yellow #110 |
| 4i | Orange | Pigment Orange #36 |
| 4j | Magenta | Pigment Red #42 |
| 4k | Red | Pigment Red #254 |
| 4l | Bluish Red | Pigment Violet #19 |
| 4m | Reddish Violet | Pigment Violet #19 |
| 4n | Maroon | Pigment Red #179 |
| 4o | Iron Oxide Yellow | Pigment Yellow #42 |
| 4p | Iron Oxide Red | Pigment Red #101 |
| 4q | Silver (Al.) Metallic | Pigment Metal #1 |
| 4r | White | Pigment White #6 |

### Comparative Example B

A blend of (meth)acrylate monomers, including sufficient hydroxylated monomer to produce a poly-hydroxy functional acrylic polyol, and initiator are metered into a solvent over a period of hours under initiator starved conditions. Once the reaction has gone to completion, solvent and residual initiator by-product are distilled from the polymer leaving an 80% weight solids acrylic polyol of 580±5 hydroxyl equivalent weight on solids. The polymer was tested at 80%±1% by weight solids and determined to have a viscosity of ˜150 poises at 25° C.

### Example 5

A sufficient amount of tertiary butyl acetoacetate is added to the product obtained in Comparative Example B to acetoacetylate 50% of the available hydroxyls. As the acrylic polyol is already diluted to 80% by weight solids in an appropriate solvent for use as a reflux solvent, no reflux solvent is added. The transesterification reaction is allowed to proceed until the theoretical amount of tertiary butyl alcohol and reflux solvent is collected. 10%±1% of the reducing solvent is extracted along with the tertiary butyl alcohol. The theoretical hydroxyl and acetoacetyl equivalent weights of this polymer are calculated to be 1245±5. A tint base is prepared using the obtained acrylic binder, an appropriate pigment wetting agent, pigment white #6, solvent and additives. A stable, high tint strength, non-flocculating dispersion is obtained.

Preparation of Clear Bases with Differing Functional Groups

### Example 6

### A Clear Base for Polyurethanes

Two hydroxylated polyols, one an acrylic and the other a polyester, are blended with solvent, flow additives, ultraviolet absorbers, and a catalyst for the urethane reaction. The amount of hydroxyl reactivity present is selected such that, when the clear base is mixed one to one by weight with any blend of the colored tints from Example 4, the finished product is completely crosslinked when mixed at a previously fixed volume ratio with a specific polyisocyanate crosslinker. The resulting product is a clear liquid with a hydroxyl equivalent weight of 425±5, a viscosity of 0.25 poises, and a weight solids of 49%±1%.

### Examples 6a, b, c & Comparative Example 6d

The dual functional binders from Examples 2, 3 and 5 and the binder from Comparative Example B are each used to prepare a titanium dioxide white tint. The tints are each mixed with the urethane clear base of this Example. The resulting mixtures are then mixed at a 3:1 volume ratio with the same polyisocyanate blend, sprayed onto metal panels and allowed to cure for two weeks under indoor ambient conditions. The resulting coated samples are then tested. All of the tints, irrespective of hydroxyl to acetoacetyl ratio showed similar cured physical properties, clearly indicating that the dual functional polymers, irrespective of hydroxyl to acetoacetyl ratio, are compatible with the combined system and perform usefully in a reaction with polyisocyanates. The testing demonstrates that the dual functional tints of this invention are suitable for use in polyurethane coating systems.

TABLE 2

| | | | | | Impact | MEK |
|---|---|---|---|---|---|---|
| | | Dry | | | Resistance | Solvent |
| | Tint | Time - | Gloss @ | Pencil | Direct/Reverse - | Double |
| Example | Binder | Hours | 60°/20° - % | Hardness | in.lbs. | Rubs |
| 6a | Ex. 2 | 2.5 | >90/>80 | H | 160/160 | >300 |
| 6b | Ex. 3 | 2.5 | >90/>80 | H | 160/160 | >300 |
| 6c | Ex. 5 | 2.0 | >90/>80 | H | 160/110 | >300 |
| 6d | Comp. | 1.4 | >90/>80 | H | 160/120 | >300 |
| (Comp.) | Ex. B | | | | | |

### Example 7

### Clear Base for Michael Addition Cured System

Two acetoacetylated polymers, one an acrylic and the other a polyester, are blended with solvent, flow additives, ultraviolet absorbers, and sufficient polyfunctional acrylate crosslinker to crosslink with the acetoacetyl functional groups present in the clear base and those present in the same weight amount of any blend of the tint bases of Example 3. The resulting product is a clear liquid with an acetoacetyl equivalent weight of 1050±5, a viscosity of 7±0.5 poises, and a weight solids of 57%±1%.

### Examples 7a, b, c, and Comparative Example 7d

The dual functional binders from Examples 2, 3, 5 and the binder from Comparative Example B are each used to prepare a titanium dioxide white tint. The tints are each mixed with the Michael Addition clear base from this Example. Each mixture is then mixed at a 3:1 volume ratio with the same base catalyst blend, sprayed onto metal panels and allowed to cure for two weeks under indoor ambient conditions. The resulting coated samples were then tested.

The tints using the dual functional binders showed differences related to both the binder type, i.e. polyester or acrylic, and to the hydroxyl to acetoacetyl ratio. The tint based on the polymer from Comparative Example B shows unacceptable properties, indicating that some acetoacetyl functionality in the binder polymer is required. All of the binders based on dual functional polymers, where at least 20% of the reactivity was acetoacetyl functionality showed useful properties. The results show that the dual functional tints of this invention are suitable for use in Michael Addition cured coating systems.

TABLE 3

| | | | | | Impact | MEK |
|---|---|---|---|---|---|---|
| | | | | | Resistance | Solvent |
| | Tint | Dry Time - | Gloss @ | Pencil | Direct/Reverse - | Double |
| Example | Binder | Hours | 60°/20° - % | Hardness | in.lbs. | Rubs |
| 7a | Ex. 2 | 1.5 | >90/>80 | H | 160/160 | >300 |
| 7b | Ex. 3 | 1.7 | >90/>80 | H | 160/40 | >300 |
| 7c | Ex. 5 | 1.4 | >90/>80 | H | 80/20 | >300 |
| 7d (comp.) | Comp. | 1.4 | >90/>80 | HB | 20/<5 | 275 |
| | Ex. B | | | | | |

### Example 8

### A Clear Base for a Single Package Hexamethoxymethyl Melamine Crosslinked System

Two hydroxylated polyester polymers are blended with solvent, additives, hexamethoxymethyl melamine and a blocked acid catalyst. Enough hexamethoxymethyl melamine is used in the system to react with the reactivity from the two polyester polyols present and the reactivity present in the same weight amount of any combination of the tint bases of Example 4. The resulting product is a clear liquid with a hydroxyl equivalent weight of 520±5, a viscosity of 0.20 poises, and a weight solids of 58%±1%.

### Example 8a and Comparison Example 8b

The dual functional binder from Example 4 is used in a white tint (Example 4r) and a comparative white tint based on the hydroxylated Comparative Example B polymer are each mixed 1:1 by weight with the clear base of this example. Each mixture is then sprayed onto metal panels and baked in an electric oven for 30 minutes at 135° C. to ensure a complete cure. The resulting coated samples are then tested. The high gloss, hardness and solvent resistance of the coating incorporating the tint of Example 4r shows that the dual functional binder reacted with the hexamethoxymethyl melamine. The results indicate that the dual functional tints of this invention are suitable for use in melamine baked systems.

TABLE 4

| | | Paint | | | | MEK |
|---|---|---|---|---|---|---|
| | | Viscosity | | | Impact Resistance | Solvent |
| | Tint | in | Gloss | Pencil | Direct/Reverse - | Double |
| Example | Binder | centipoises | @60° - % | Hardness | in.lbs. | Rubs |
| 8a | Ex. 4 | 80 ± 5 | >90 | H-2H | 30/5 | >200 |
| 8b | Comp. | 80 ± 5 | >90 | HB | 60/10 | >200 |
| (comp.) | Ex. B | | | | | |

### Example 9

### A Base for an Amine Crosslinked Epoxy System

A blend of inorganic fillers suitable for a corrosion resistant primer are dispersed under high shear conditions into a bisphenol A based epoxy resin, solvents, a wetting agent for the fillers, a thixotrope, and other additives. The amount of epoxide reactivity present is selected such that, when this base is mixed nine to one by weight with any blend of the colored tints from Example 4, the finished product would be completely crosslinked when mixed at a previously fixed volume ratio with a specific polyamine crosslinker. The resulting product is a hazy liquid with an epoxide equivalent weight of 1110±50, a thixotropic viscosity profile, and a weight solids of 80%±1%.

### Example 9a and Comparison Example 9b

The tints of Examples 4a and 4r are mixed in a 1:9 ratio and added as described above to the epoxy binder of this Example. A comparative composition is produced directly from the same epoxy resin used in the binder of this Example. The reactivity is controlled such that there is the same amount of amine reactive functionality in both the example coating and the comparative coating. Each composition is then sprayed onto metal panels and cured under indoor ambient conditions for two weeks to ensure a complete cure. The resulting coated samples are then tested. The high hardness, faster cure and solvent resistance of the coating incorporating the Example tints 4a and 4r shows that the dual functional binder reacted with the amine crosslinker. These results show that the dual functional tints of this invention are suitable for use in epoxy systems.

TABLE 5

| | | | | | | MEK |
|---|---|---|---|---|---|---|
| | | Dry | | | Impact | Solvent |
| | | Time - | Pot Life - | Pencil | Resistance | Double |
| Example | Tint Binder | Hours | Hours | Hardness | Direct - in.lbs. | Rubs |
| 9a | Ex. 4 | 4.8 | >5 | 3H | 40 | >100 |
| Comparison | Epoxy | 5.8 | >5 | 2H | 40 | >100 |
| 9b | resin | | | | | |

### Example 10

### A base for a Single Package Oxidative Cure System

A 75% weight solids chain stopped short oil alkyd is blended with reactive diluent, solvent, flow additives and a cobalt based catalyst for the oxidative crosslinking reaction. A sufficient amount of cobalt catalyst is added to provide useful catalysis when this clear base is mixed one to one by weight with any blend of the colored tints from Example 4. The resulting product is a clear liquid with a viscosity of ˜0.5 poises, and a weight solids of 65%±1%.

### Example 10a and Comparison Example 10b

The dual functional binder from Example 4 used in a white tint (Example 4r) and a comparative white tint based on the same short oil alkyd polymer used in the above clear base are each mixed 1:1 by weight with the clear base of this example. Each mixture is then sprayed onto metal panels and allowed to cure under indoor ambient conditions for two weeks to ensure a complete cure. The resulting coated samples are then tested. The high gloss, equivalent hardness and equivalent impact resistance of the coating incorporating the Example tint 4r shows that the dual functional binder used entered into the oxidative reaction. These results demonstrate that the dual functional tints of this invention are suitable for use in oxidative cure systems.

TABLE 6

| | | Dry Time - | Gloss | Pencil | Impact Resistance |
|---|---|---|---|---|---|
| Example | Tint Binder | Hours | @60°/20 - % | Hardness | Direct - in.lbs. |
| 10a | Ex. 4 | 10 | >90/>80 | HB | 10 |
| 10b (comp) | alkyd | 10 | >90/>80 | HB | 10 |

### Examples 11a-d

### Clear Bases for Non-Reactive Lacquer Systems

½ second RS type nitrocellulose is dissolved in a solvent along with phthalate ester plasticizer, aldehyde resin, and additives. A high acid value thermoplastic acrylic resin (Joncryl 611 from the S. C. Johnson Corp.) is dissolved in a solvent. The same high acid value resin is dissolved and neutralized with triethylamine. A thermoplastic acrylic resin (Parapol DM-55 from Rohm and Haas Corp.) used in various coatings applications is dissolved in a solvent. Each of the above bases is mixed with the dual functional resin from Example 3 at a ratio of 5:2 on polymer solids, which simulates the typical use ratio for the resin from Example 3, if it were used in a colored tint. In all cases the resin blends are clear, single phase light colored liquids.

The above blends of resin and dual functional polymer are then applied by draw down bar at ˜150 microns wet onto clear glass panels and dried. The dried films are clear and haze free with very high gloss and no surface exudation. These results indicate the compatibility of the dual functional resin of the present invention with several types of lacquer drying binders. By extension this indicates that tints made from the dual functional binder of Example 3 will have the same excellent compatibility and will be suitable for use with appropriately formulated lacquer dry coating systems.

In the above detailed description, reference was made by way of non-limiting example to preferred embodiments of the invention. Obviously, numerous modifications and variations of the present invention are possible in light of the above teachings. It is therefore to be understood that within the scope of the appended claims, the invention may be practiced otherwise than as specifically described herein.

1. A tint base, comprising:
a dual functional polymer; and
a pigment.

2. The tint base of claim 1, wherein the dual functional polymer comprises a plurality of hydroxyl functional groups and a plurality of acetoacetyl functional groups.

3. The tint base of claim 1, wherein the dual functional polymer comprises from 5 to 80% hydroxyl functional groups and from 20 to 95% acetoacetyl functional groups relative to a total number of hydroxyl functional groups and acetoacetyl functional groups.

4. The tint base of claim 1, wherein the dual functional polymer comprises from 20 to 60% hydroxyl functional groups and from 40 to 80% acetoacetyl functional groups relative to a total number of hydroxyl functional groups and acetoacetyl functional groups.

5. The tint base of claim 1, wherein the dual functional polymer comprises a condensation polymer.

6. The tint base of claim 1, wherein the dual functional polymer comprises a (meth)acrylate polymer.

7. The tint base of claim 1, wherein the dual functional polymer comprises a polymer backbone selected from the group consisting of polyesters and poly(meth)acrylates.

8. The tint base of claim 1, wherein the dual functional polymer has a number average molecular weight of from 1,000 to 10,000.

9. The tint base of claim 1, wherein the dual functional polymer has a number average molecular weight of from 1,000 to 6,000.

10. The tint base of claim 1, wherein the pigment comprises at least one member selected from the group consisting of organic and inorganic pigments.

11. The tint base of claim 1, wherein the pigment further comprises a dispersing agent.

12. The tint base of claim 1, further comprising a wetting agent.

13. A coating composition, comprising:
the tint base of claim 1; and
a coating base.

14. The coating composition of claim 13, wherein the coating base comprises a urethane binder.

15. The coating composition of claim 13, wherein the coating base comprises a Michael addition binder.

16. The coating composition of claim 13, wherein the coating base comprises a melamine binder.

17. The coating composition of claim 13, wherein the coating base comprises an epoxy binder.

18. The coating composition of claim 13, wherein the coating base comprises a binder curable by an oxidative crosslinking reaction.

19. The coating composition of claim 13, wherein the coating base comprises a non-reactive lacquer.

20. The coating composition of claim 13, wherein the coating base comprises at least one modifier selected from the group consisting of flow additives, ultraviolet absorbers and reaction catalysts.

21. A method of coating, comprising:
applying the coating composition of claim 13 to a substrate; and
curing the coating composition.

22. A kit, comprising:
a first container comprising a first coating composition; and
a second container comprising a second coating composition;
wherein:
the first coating composition comprises the coating composition of claim 13; and
the second coating composition comprises a reactive component.

23. The kit according to claim 22, wherein the reactive component comprises a polyisocyanate.

24. The kit according to claim 22, wherein the reactive component comprises a Michael addition base catalyst.

25. The kit according to claim 22, wherein the reactive component comprises an epoxy curing agent.

26. The kit according to claim 22, wherein:
the first coating composition comprises a coating base comprising acetoacetyl functional polymers and acrylate functional urethane crosslinkers; and
the second coating composition comprises a strong base catalyst.

27. A method of coating, comprising:
obtaining the kit of claim 22;
mixing the first coating composition and the second coating composition to obtain a combined coating composition;
applying the combined coating composition to a substrate; and
curing the combined coating composition.

28. A method of preparing a tint base, comprising:
obtaining a dual functional polymer;
obtaining a pigment; and
combining the dual functional polymer and the pigment.

29. The method of claim 28, wherein obtaining a dual functional polymer comprises preparing a dual functional polymer.

30. The method of claim 29, wherein preparing the dual functional polymer comprises:
preparing a polyester having hydroxyl functional groups by esterification; and
acetoacetylating a plurality of the hydroxyl functional groups by transesterification so that the dual functional polymer includes both hydroxyl functional groups and acetoacetyl functional groups.

31. The method of claim 29, wherein preparing the dual functional polymer comprises preparing a dual functional poly(meth)acrylate by free radical polymerization of hydroxyl functional (meth)acrylate and acetoacetyl functional (meth)acrylate.

32. The method of claim 29, wherein obtaining the pigment comprises obtaining a pigment selected from the group consisting of organic and inorganic pigments.

33. The method of claim 29, wherein obtaining the pigment comprises preparing a dispersion of the pigment in a dispersing agent.

34. The method of claim 29, wherein combining the dual functional polymer and the pigment comprises dispersing the pigment in the dual functional polymer.

35. The method of claim 34, wherein dispersing the pigment in the dual functional polymer comprises dispersing with an apparatus selected from the group consisting of a bead mill, a ball mill, a two roll mill and a three roll mill.
